(19) United States
(12) Patent Application Publication
(10) Pub. No.: US 2018/0272456 A1
(43) Pub. Date: Sep. 27, 2018

(54) METHOD FOR PRODUCING PRISMATIC SECONDARY BATTERY

(71) Applicant: Sanyo Electric Co., Ltd., Osaka (JP)

(72) Inventors: Kyohei Kobayashi, Hyogo (JP); Takashi Hosokawa, Hyogo (JP); Hidekazu Tamai, Kyoto (JP)

(73) Assignee: Sanyo Electric Co., Ltd., Osaka (JP)

(21) Appl. No.: 15/921,113

(22) Filed: Mar. 14, 2018

(30) Foreign Application Priority Data
Mar. 27, 2017 (JP) 2017-061814

(51) Int. Cl. B23K 11/00; H01M 10/04

(52) U.S. Cl. CPC B23K 11/002; B23K 2201/38; H01M 2220/20; H01M 10/0413

(57) ABSTRACT

A negative electrode current collector is placed on outer sides of two outermost surfaces of a layered negative electrode core-exposed portion, and a negative electrode conductive member is placed between first and second layered negative electrode core-exposed portions formed by dividing the layered negative electrode core-exposed portion into two parts. A resistance-welding electrode is brought into contact with the negative electrode current collector from the side opposite to the layered negative electrode core-exposed portion side, and the negative electrode current collector, the layered negative electrode core-exposed portion, and the negative electrode conductive member are resistance-welded together. In a placing step, the negative electrode conductive member is placed such that the protrusions thereof are in contact with the first and second layered negative electrode core-exposed portions located between the negative electrode conductive member and the negative electrode current collector, and the protrusions are then melted.

### CROSS REFERENCE TO RELATED APPLICATIONS

The present invention application claims priority to Japanese Patent Application No. 2017-061814 filed in the Japan Patent Office on Mar. 27, 2017, the entire contents of which are incorporated herein by reference.

### BACKGROUND OF THE INVENTION

### Field of the Invention

The present disclosure relates to a method for producing a prismatic secondary battery.

### Description of Related Art

An example of a prismatic secondary battery in the related art is described in Japanese Published Unexamined Patent Application No. 2012-33334 (Patent Document 1). Such a prismatic secondary battery is installed in vehicles and has a flat wound electrode body in which a positive electrode plate and a negative electrode plate are wound with a separator interposed therebetween. In the positive electrode plate, a positive electrode active material mixture layer is provided on each surface of a strip-shaped positive electrode core, and a positive electrode core-exposed portion where the positive electrode core is exposed as a strip shape is provided at one end portion of each surface in the width direction. In the negative electrode plate, a negative electrode active material mixture layer is provided on each surface of a strip-shaped negative electrode core, and a negative electrode core-exposed portion where the negative electrode core is exposed as a strip shape is provided at the other end portion of each surface in the width direction. The positive electrode active material mixture layer and the negative electrode active material mixture layer can each intercalate and deintercalate lithium ions.

The prismatic secondary battery further includes a positive electrode current collector electrically connected to the positive electrode core-exposed portion, a negative electrode current collector electrically connected to the negative electrode core-exposed portion, an electrolyte, a prismatic outer can, and a sealing plate. The electrode body is inserted into the prismatic outer can such that the positive electrode core-exposed portion and the negative electrode core-exposed portion are located at different end portions of the prismatic outer can in the width direction. The electrolyte is enclosed in a case formed by sealing an opening of the prismatic outer can with the sealing plate.

The positive electrode current collector is electrically connected to a positive electrode terminal, and the negative electrode current collector is electrically connected to a negative electrode terminal.

### BRIEF SUMMARY OF THE INVENTION

Prismatic secondary batteries for vehicles and other applications are designed to output high power. To reduce the resistance, there is provided a current collecting structure in which a layered negative electrode core-exposed portion on one end portion of the electrode body is collectively electrically connected by resistance welding to a negative electrode current collector and electrically connected to a negative electrode terminal via the negative electrode current collector. There is also provided a current collecting structure in which a layered positive electrode core-exposed portion on one end portion of the electrode body is collectively electrically connected by resistance welding to a positive electrode current collector and electrically connected a positive electrode terminal via the positive electrode current collector.

In view of such circumstances, to achieve higher capacity by taking advantage of battery inner space, the proportion of an active material is desirably increased by relatively increasing the thickness of an active material mixture layer in a positive/negative electrode plates or by reducing the width of a core-exposed portion to increase the width of active material mixture layers formed on a core. However, when the thickness of a positive/negative electrode plate is relatively increased or the width of a core-exposed portion is reduced, the extending direction in which a positive/negative electrode core-exposed portion on the outer circumferential side of an electrode plate extends to the contact end in contact with a current collector forms a steep angle with the axial direction of an electrode body.

The present disclosure is directed to a method for producing a prismatic secondary battery by using resistance welding. In this method, breakage of the negative electrode core-exposed portion can be suppressed and formation of wrinkles in the negative electrode place can also be suppressed.

A method for producing a prismatic secondary battery according to an embodiment the present disclosure is a method for producing a prismatic secondary battery including a flat electrode body containing a positive electrode plate and a negative electrode plate. The negative electrode plate includes a negative electrode core made of a copper foil or a copper alloy foil and a negative electrode active material mixture layer on the negative electrode core. The flat electrode body has a layered negative electrode core-exposed portion on an end portion. The layered negative electrode core-exposed portion includes a first layered negative electrode core-exposed portion and a second layered negative electrode core-exposed portion with a distance therebetween. The prismatic secondary battery further includes a current collector electrically connected to two outermost surfaces of the layered negative electrode core-exposed portion, and a conductive member made of a metal between the first layered negative electrode core-exposed portion and the second layered negative electrode core-exposed portion. The method includes a placing step of placing a current collector on outer sides of two outermost surfaces of the layered negative electrode core-exposed portion and placing the conductive member between the first layered negative electrode core-exposed portion and the second layered negative electrode core-exposed portion, the conductive member having protrusions; and a welding step of bringing a resistance-welding electrode into contact with a current collector from the side opposite to the layered negative electrode core-exposed portion side and resistance-welding the current collector, the negative electrode core-exposed portion, and the conductive member together. The breaking elongation of the negative electrode core is 5.6% or higher and 12.0% or lower. During the welding step, the protrusions on the conductive member are melted by causing a resistance welding current to flow while the protrusions on the conductive member contact the negative electrode core-exposed portion located between the conductive member and the current collector.

The method for producing a prismatic secondary battery according to the present disclosure involves performing resistance welding while the conductive member is placed between the first layered negative electrode core-exposed portion and the second layered negative electrode core-exposed portion. Because of this process, the width of the negative electrode core-exposed portion can be reduced. The width of the negative electrode active material mixture layer can be increased accordingly, which provides a prismatic secondary battery with a high capacity. When the conductive member is provided with the protrusions and resistance welding is performed while the protrusions contact the negative electrode core-exposed portion, the resistance welding current concentrates, which makes resistance welding more stable.

However, since the negative electrode current collector is pressed with the resistance-welding electrode toward the conductive member during resistance welding, the negative electrode current collector moves toward the conductive member as a result of melting of the protrusions on the conductive member. The end of the negative electrode current collector then strongly presses the negative electrode core-exposed portion on the outermost surface toward the conductive member, which may break the negative electrode core-exposed portion. This issue becomes obvious when the extending direction in which the negative electrode core-exposed portion on the outer circumferential side of the negative electrode plate extends to the contact end in contact with the negative electrode current collector forms a steep angle with the axial direction of the electrode body.

The inventors of the present disclosure have found that such breakage of the negative electrode core-exposed portion can be suppressed by using a negative electrode core having a breaking elongation of 5.6% or higher.

However, the inventors have found an issue of possible formation of wrinkles in the negative electrode plate during production of the negative electrode place as a new issue occurring when using a negative electrode core having a breaking elongation of 5.6% or higher. As a result of further studies, it has been found that breakage of the negative electrode core can be suppressed and formation of wrinkles in the negative electrode plate can also be suppressed by using a negative electrode core having a breaking elongation of 5.6% or higher and 12.0% or lower.

A method for producing a prismatic secondary battery according to an embodiment the present disclosure is a method for producing a prismatic secondary battery including a flat electrode body containing a positive electrode plate and a negative electrode plate. The negative electrode plate includes a negative electrode core made of a copper foil or a copper alloy foil and a negative electrode active material mixture layer on the negative electrode core. The flat electrode body has a layered negative electrode core-exposed portion on an end portion. A current collector is placed on the outermost surface of the layered negative electrode core-exposed portion. The method includes a placing step of placing a current collector on the outermost surface of the layered negative electrode core-exposed portion, the current collector having a protrusion; and a welding step of bringing a resistance-welding electrode into contact with the current collector from the side opposite to the layered negative electrode core-exposed portion side and resistance-welding the current collector and the negative electrode core-exposed portion together. The breaking elongation of the negative electrode core is 5.6% or higher and 12.0% or lower. The protrusion on the current collector is melted by causing a resistance welding current to flow while the protrusion on the current collector contacts the negative electrode core-exposed portion.

In the method for producing a prismatic secondary battery according to this embodiment of the present disclosure, a protrusion is provided on the surface of the negative electrode current collector facing the negative electrode core-exposed portion. When resistance welding is performed while the protrusion contacts the negative electrode core-exposed portion, the resistance welding current concentrates, which makes resistance welding more stable.

However, since the negative electrode current collector is pressed with the resistance-welding electrode toward the conductive member during resistance welding, the body of the negative electrode current collector moves toward the negative electrode current collector as a result of melting of the protrusion on the negative electrode current collector. The end of the body of the negative electrode current collector then strongly presses the negative electrode core-exposed portion on the outermost surface toward the conductive member, which may break the negative electrode core-exposed portion. This issue becomes obvious when the extending direction in which the negative electrode core-exposed portion on the outer circumferential side of the negative electrode plate extends to the contact end in contact with the negative electrode current collector forms a steep angle with the axial direction of the electrode body.

The inventors of the present disclosure have found that such breakage of the negative electrode core-exposed portion can be suppressed by using a negative electrode core having a breaking elongation of 5.6% or higher.

However, the inventors have found an issue of possible formation of wrinkles in the negative electrode plate during production of the negative electrode place as a new issue occurring when using a negative electrode core having a breaking elongation of 5.6% or higher. As a result of further studies, it has been found that breakage of the negative electrode core can be suppressed and formation of wrinkles in the negative electrode plate can also be suppressed by using a negative electrode core having a breaking elongation of 5.6% or higher and 12.0% or lower.

In the methods for producing a prismatic secondary battery according to the embodiments of the present disclosure, breakage of the negative electrode core-exposed portion can be suppressed, and formation of wrinkles in the negative electrode plate can also be suppressed.

### BRIEF DESCRIPTION OF THE SEVERAL VIEWS OF THE DRAWINGS

FIG. 1A is a plan view of a prismatic secondary battery that can be produced by the method of the present disclosure, and FIG. 1B is a front view of the prismatic secondary battery;

FIG. 2A is a partial sectional view taken along line IIA-IIA in FIG. 1A, FIG. 2B is a partial sectional view taken along line IIB-IIB in FIG. 2A, and FIG. 2C is a sectional view taken along line IIC-IIC in FIG. 2A;

FIG. 3A is a plan view of a positive electrode plate in the prismatic secondary battery, and FIG. 3B is a plan view of a negative electrode plate in the prismatic secondary battery;

FIG. 4 is a developed perspective view of a flat wound electrode body, which is contained in the prismatic secondary battery, on the winding end side;

FIG. 5 is a view illustrating a test piece used to measure the breaking elongation;

FIG. 6 is a schematic view for describing resistance welding on the negative electrode side;

FIG. 7 is a schematic view for describing resistance welding on the negative electrode side;

FIG. 8 is a schematic view for describing resistance welding on the negative electrode side;

FIG. 9 is a partially enlarged view on the negative electrode side of FIG. 2B; and

FIG. 10 is a figure showing the relationship among the elongation of the core, occurrence of electrode plate breakage, and formation of wrinkles on the negative electrode side.

### DETAILED DESCRIPTION OF THE INVENTION

Embodiments according the present disclosure will be described below in detail with reference to the accompanying drawings. The following embodiments are illustrated for understanding the technical idea of the present disclosure. It is not intended to limit the present disclosure to these embodiments. For example, it has already been presumed that the features of the embodiments or modifications described below are appropriately combined to construct new embodiments. The present disclosure can also be equally applied to various modifications without departing from the technical idea described in the claims.

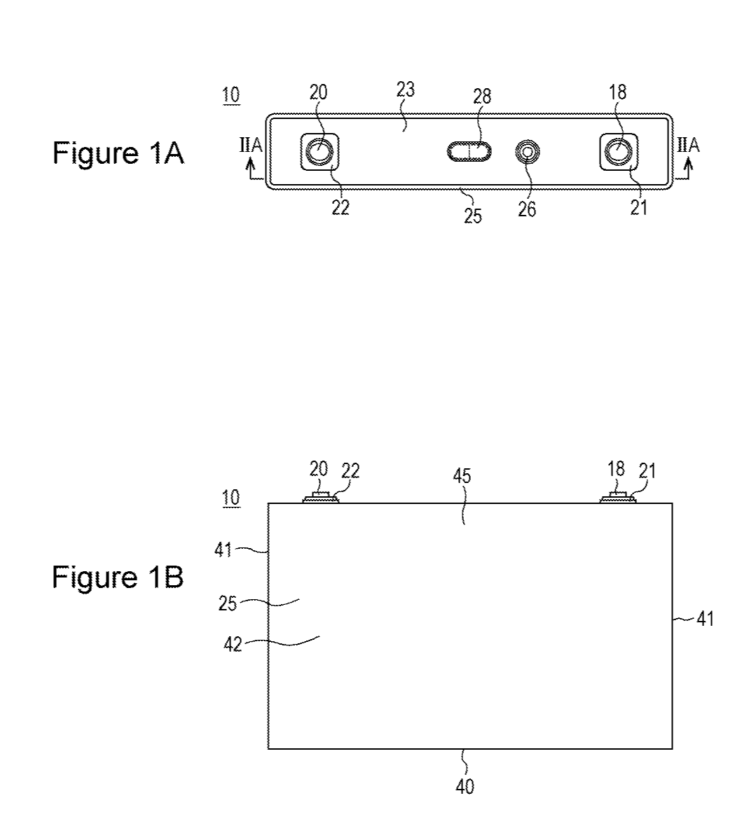

First, with reference to FIG. 1A to FIG. 4, the schematic configuration of a prismatic secondary battery 10 that can be produced by the production method of the present disclosure will be described.

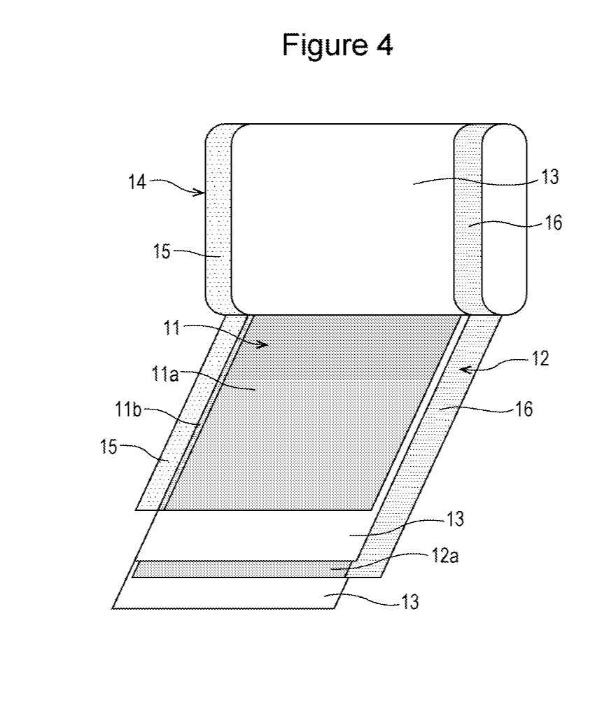

As in FIG. 1A, FIG. 1B, and FIG. 4, the prismatic secondary battery 10 includes a prismatic outer body (prismatic outer can) 25, a sealing plate 23, and a flat wound electrode 14. The prismatic outer body 25 is made of for example, aluminum or an aluminum alloy and has an opening on one side in the height direction. As illustrated in FIG. 1B, the prismatic outer body 25 has a bottom 40, a pair of first side surfaces 41, and a pair of second side surfaces 42. The pair of second side surfaces 42 is larger than the pair of first side surfaces 41. The sealing plate 23 is fitted into the opening of the prismatic outer body 25, and the sealing plate 23 and the prismatic outer body 25 are joined together at the fitting portion therebetween to form a prismatic battery case 45.

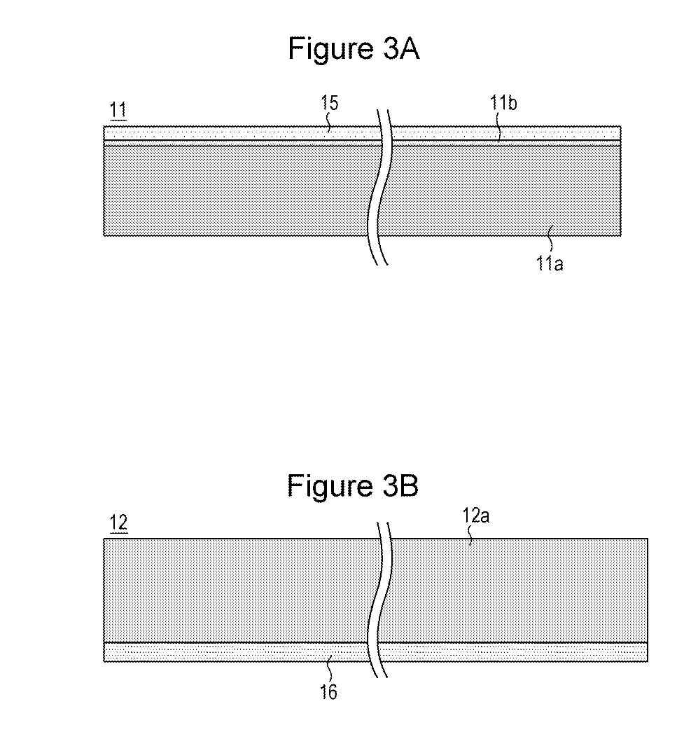

As illustrated in FIG. 4, the wound electrode body 14 has a structure in which a positive electrode plate 11 and a negative electrode plate 12 are insulated from each other with a separator 13 interposed therebetween. The wound electrode body 14 has the separator 13 on the outermost surface side. The negative electrode plate 12 is located circumferentially outward of the positive electrode plate 11. The total number of layers of the positive electrode plate 11 in the flat part of the flat wound electrode body 14 (hereinafter, the total number of layers is defined as the number of layers of the positive electrode plate) is 40 or more (the winding number is 20 or more), preferably 50 or more (the winding number is 25 or more), and more preferably 60 or more (the winding number is 30 or more). The positive electrode plate 11 is prepared by applying a positive electrode active material mixture slurry to both sides of a positive electrode core made of an aluminum or aluminum alloy foil about 10 to 20 μm in thickness, followed by drying and rolling, and cutting the obtained product in a strip shape of a predetermined size. As illustrated in FIG. 3A, the positive electrode plate 11 has a positive electrode active material mixture layer 11a on a strip-shaped positive electrode core. The positive electrode plate 11 has a positive electrode core-exposed portion 15 on one end portion in the width direction. The positive electrode core-exposed portion 15 extends in the longitudinal direction. A portion of the positive electrode core exposed as a strip shape serves as the positive electrode core-exposed portion 15. For example, a positive electrode protective layer 11b is formed on at least one surface of the positive electrode core-exposed portion 15 such that the positive electrode protective layer 11b extends in the longitudinal direction of the positive electrode core-exposed portion 15 so as to adjoin the positive electrode active material mixture layer 11a. The positive electrode protective layer 11b has lower conductivity than the positive electrode active material mixture layer 11a. The positive electrode protective layer 11b contains, for example, a binder and inorganic particles such as those made of alumina. As desired, a small amount of a conductive agent, such as a carbon material, can also be added to the positive electrode protective layer 11b. The positive electrode protective layer 11b is not necessarily formed.

The negative electrode plate 12 is prepared by applying a negative electrode active material mixture slurry to both sides of a negative electrode core made of a copper or copper alloy foil about 5 to 20 μm in thickness, followed by drying and rolling, and cutting the obtained product in a strip shape of a predetermined size. As illustrated in FIG. 3B, the negative electrode plate 12 includes a negative electrode active material mixture layer 12a on a strip-shaped negative electrode core. The negative electrode plate 12 has a negative electrode core-exposed portion 16 on one end portion in the width direction. The negative electrode core-exposed portion 16 extends in the longitudinal direction. The positive electrode core-exposed portion 15 may be formed at both end portions of the positive electrode plate 11 in the width direction. The negative electrode core-exposed portion 16 may be formed at both end portions of the negative electrode plate 12 in the width direction.

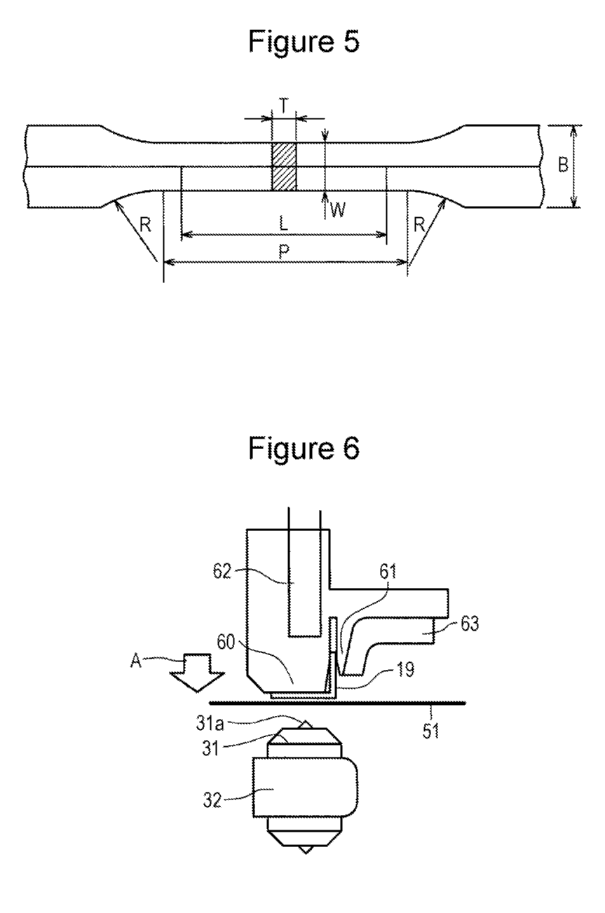

The breaking elongation of the negative electrode core is 5.6% or higher and 12.0% or lower. The breaking elongation is measured according to JIS Z 2201 (shape of test piece) and JIS Z 2241 (measurement method) [1998 edition] under the following conditions: test piece 13B; test speed 20 mm/min; quantity n=3; measurement item, tensile strength=maximum tension/foil sectional area; and elongation, displacement/reference length (60 mm). The test piece 13B is a test piece illustrated in FIG. 5 where the width W is 12.5 mm, the original gauge length L is 50 mm, the length P of the parallel portion is about 60 mm, the radius R of the shoulders is 20 to 30 mm, the thickness T remains original thickness, and the width B of the grip is 20 mm or more.

As illustrated in FIG. 4, the positive electrode plate 11 and the negative electrode plate 12 are displaced from each other in the width direction of the wound electrode body 14 (in the width direction of the positive electrode plate 11 and the negative electrode plate 12) with respective to the opposite electrode mixture layers 11a and 12a such that the positive electrode core-exposed portion 15 and the negative electrode core-exposed portion 16 do not overlap with their corresponding opposite electrode mixture layers 12a and 11a. The positive electrode plate 11 and the negative electrode plate 12 are wound in a flat form while they are insulated from each other with a separator 13 interposed therebetween, producing a flat wound electrode body 14. The wound electrode body 14 includes a multi-layered positive electrode core-exposed portion 15 at one end portion in the direction in which the winding axis extends (corresponding to the width direction of the strip-shaped positive electrode plate 11, the strip-shaped negative electrode plate 12, and the strip-shaped separator 13 when developed in rectangular shapes). The wound electrode body 14 includes a multi-layered negative electrode core-exposed portion 16 at the other end portion. The separator 13 is preferably a polyolefin microporous membrane. The width of the separator 13 is preferably large enough to cover the positive electrode active material mixture layer 11a and the positive electrode protective layer 11b and larger than the width of the negative electrode active material mixture layer 12a.

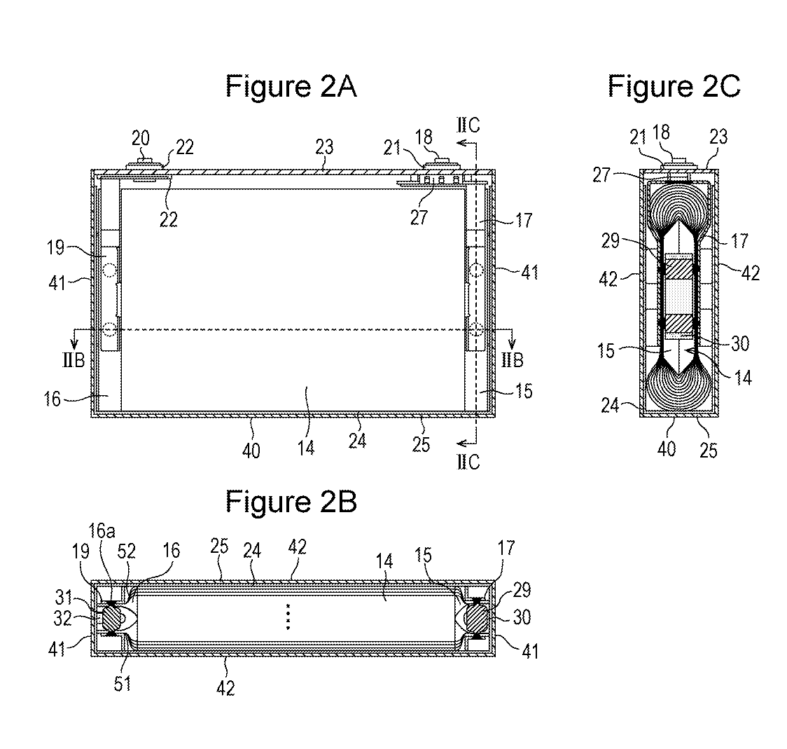

As described below, the multi-layered positive electrode core-exposed portion 15 is electrically connected to a positive electrode terminal 18 via a positive electrode current collector 17 (see FIG. 2A). The multi-layered negative electrode core-exposed portion 16 is electrically connected to a negative electrode terminal 20 via a negative electrode current collector 19 (see FIG. 2A). Although not described in detail, as illustrated in FIG. 2A, a current interrupting mechanism 27 is preferably provided between the positive electrode current collector 17 and the positive electrode terminal 18. The current interrupting mechanism 27 operates at a time when the gas pressure in the battery case 45 reaches a predetermined value or higher. The current interrupting mechanism 27 is an optional component.

As illustrated in FIG. 1A, FIG. 1B, and FIG. 2A, the positive electrode terminal 18 is fixed to the sealing plate 23 with an insulating member 21 interposed therebetween, and the negative electrode terminal 20 is fixed to the sealing plate 23 with an insulating member 22 interposed therebetween. The sealing plate 23 has a gas release valve 28, which opens at a time when the gas pressure in the battery case 45 is higher than the operating pressure of the current interrupting mechanism 27. The positive electrode current collector 17, the positive electrode terminal 18, and the sealing plate 23 are each formed of aluminum or an aluminum alloy. The negative electrode current collector 19 and the negative electrode terminal 20 are each formed of copper or a copper alloy. As illustrated in FIG. 2C, the flat wound electrode body 14 is inserted into the prismatic outer body 25 whose one surface is open while an insulative sheet (resin sheet) 24 is placed between the prismatic outer body 25 and the surrounding areas of the flat wound electrode body 14 except for the area on the sealing plate 23 side.

As illustrated in FIG. 2B and FIG. 2C, on the positive electrode plate 11 side, a wound and multi-layered positive electrode core-exposed portion 15 is converged into a center part in the thickness direction and further divided into two parts, which are each centered at a depth of a quarter of the thickness of the flat wound electrode body. The positive electrode intermediate member 30 is interposed between these two parts. The positive electrode intermediate member 30 is made of a resin material, and the positive electrode intermediate member 30 has one or more, for example, two positive electrode conductive members 29. Each positive electrode conductive member 29 has, for example, a cylindrical shape and has a truncated cone-shaped protrusion that functions as a projection on each end portion facing the layered positive electrode core-exposed portion 15.

On the negative electrode plate 12 side, as illustrated in FIG. 2B, a wound and multi-layered negative electrode core-exposed portion 16 is also converged on the center side in the thickness direction and further divided into two parts, which are each centered at a depth of a quarter of the thickness of the flat wound electrode body 14. In other words, the layered negative electrode core-exposed portion 16 includes a first layered negative electrode core-exposed portion 51 and a second layered negative electrode core-exposed portion 52 with a distance therebetween.

A negative electrode intermediate member 32 is interposed between the first layered negative electrode core-exposed portion 51 and the second layered negative electrode core-exposed portion 52. The negative electrode intermediate member 32 is made of a resin material, and the negative electrode intermediate member 32 has one or more, for example, two negative electrode conductive members 31. The negative electrode intermediate member 32 is an optional member and can be omitted. The negative electrode conductive member 31 has, for example, a cylindrical shape and has a truncated cone-shaped protrusion that functions as a projection on each end portion facing the layered negative electrode core-exposed portion 16. When the positive electrode and negative electrode intermediate members 30 and 32 are provided with two or more positive electrode and negative electrode conductive members 29 and 31, these two or more positive electrode and negative electrode conductive members 29 and 31 are retained by the corresponding positive electrode and negative electrode intermediate members 30 and 32. As a result, the dimensional accuracy of these two or more positive electrode and negative electrode conductive members 29 and 31 is improved, and the positive electrode and negative electrode conductive members 29 and 31 can stably be positioned between two divided parts of the positive electrode and the negative electrode core-exposed portions 15 and 16.

Each positive electrode conductive member 29 is electrically connected by resistance welding to the converged parts of the positive electrode core-exposed portion 15 on both sides of the positive electrode conductive member 29 in the direction in which the positive electrode conductive member 29 extends. The converged parts of the positive electrode core-exposed portion 15 are electrically connected by resistance welding to the positive electrode current collector 17 located on the outer side in the depth direction of the battery case 45.

Similarly, each negative electrode conductive member 31 is electrically connected by resistance welding to the converged parts of the negative electrode core-exposed portion 16 on both sides of the negative electrode conductive member 31. The converged parts of the negative electrode core-exposed portion 16 are electrically connected by resistance welding to the negative electrode current collector 19 located on the outer side in the depth direction of the battery case 45. Such resistance welding will be described below with reference to FIG. 6 to FIG. 8.

One end of the positive electrode current collector 17 opposite to the other end on the positive electrode core-exposed portion 15 side is electrically connected to the positive electrode terminal 18. One end of the negative electrode current collector 19 opposite to the other end on the negative electrode core-exposed portion 16 side is electrically connected to the negative electrode terminal 20. As a result, the positive electrode core-exposed portion 15 is electrically connected to the positive electrode terminal 18, and the negative electrode core-exposed portion 16 is electrically connected to the negative electrode terminal 20. The wound electrode body 14, the positive electrode and negative electrode intermediate members 30 and 32, and the positive electrode and negative electrode conductive members 29 and 31 are connected to each other by resistance welding to form an integral structure. The positive electrode conductive members 29 are preferably made of aluminum or an aluminum alloy, which is the same material as that for the positive electrode core. The negative electrode conductive members 31 are preferably made of copper or a copper alloy, which is the same material as that for the negative electrode core. The positive electrode conductive members 29 and the negative electrode conductive members 31 may have the same shape or different shapes.

As illustrated in FIG. 1A, the sealing plate 23 has an electrolyte injection port 26. The above-described integral structure formed by resistance welding and other mechanical parts are placed at predetermined positions in the prismatic outer body 25. The sealing plate 23 and the prismatic outer body 25 are then laser-welded together at the fitting portion therebetween, and a non-aqueous electrolyte is then injected through the electrolyte injection port 26. Subsequently, the electrolyte injection port 26 is sealed to produce a prismatic secondary battery 10. Sealing of the electrolyte injection port 26 is performed by, for example, blind riveting or welding.

The case where the winding axis of the wound electrode body 14 is parallel to the bottom 40 of the prismatic outer body 25 is described above. The winding axis of the wound electrode body may be perpendicular to the bottom 40 of the prismatic outer body 25. An example where the prismatic secondary battery 10 has the wound electrode body 14 is described above. The prismatic secondary battery may have a stacked electrode body.

Next, resistance welding on the negative electrode side will be described with reference to FIG. 6 to FIG. 8, which are schematic views for describing resistance welding on the negative electrode side. The description of resistance welding on the positive electrode side performed in the same manner as that on the negative electrode side is omitted. The first layered negative electrode core-exposed portion 51 and the second layered negative electrode core-exposed portion 52 are resistance-welded to the respective sides of the negative electrode conductive member 31 in the extending direction, simultaneously. The description of resistance welding of the second layered negative electrode core-exposed portion 52, which is performed in the same manner as that for resistance welding of the first layered negative electrode core-exposed portion 51, is omitted. FIG. 6 to FIG. 8 illustrate only the negative electrode core-exposed portion 16 on the outermost surface as the first layered negative electrode core-exposed portion 51.

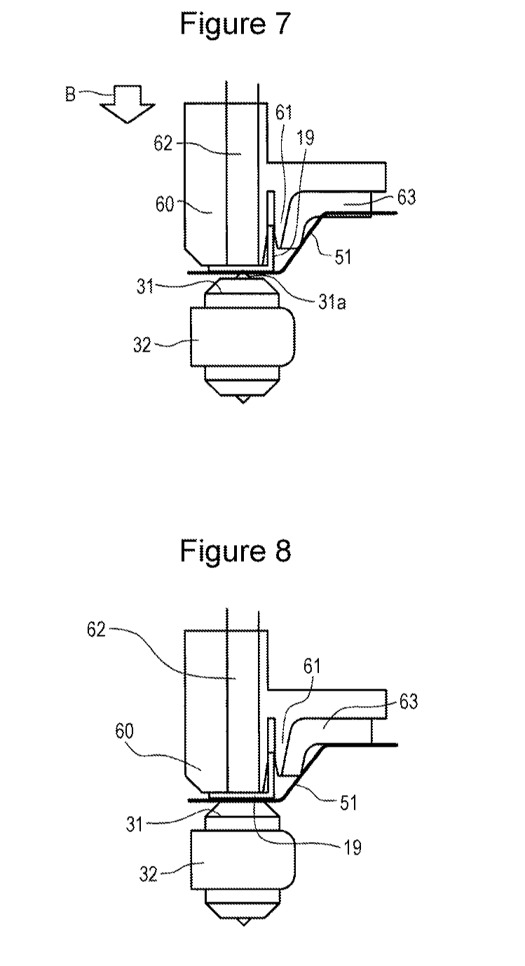

Resistance welding first involves carrying out a negative electrode core-exposed portion concentrating step illustrated in FIG. 6. In the negative electrode core-exposed portion concentrating step, a current-collector pressing member 60 moves downward in the direction indicated by arrow A. The current-collector pressing member 60 presses the first layered negative electrode core-exposed portion 51 with the negative electrode current collector 19 interposed therebetween so as to move the first layered negative electrode core-exposed portion 51 toward the negative electrode conductive member 31. The first layered negative electrode core-exposed portion 51 is pulled toward the negative electrode conductive member 31 as the first layered negative electrode core-exposed portion 51 moves toward the negative electrode conductive member 31. As illustrated in FIG. 7, the negative electrode current collector 19 concentrates the first layered negative electrode core-exposed portion 51 and allows the inner side of the first layered negative electrode core-exposed portion 51 to contact the protrusions (projections) 31a on the ends of the negative electrode conductive member 31 in the extending direction. In the state illustrated in FIG. 7, a sponge 63 attached outside (on the right side in FIG. 7) the current-collector pressing member 60 contacts the first layered negative electrode core-exposed portion 51, and the first layered negative electrode core-exposed portion 51 is pressed in a state where the sponge 63 makes it difficult to scratch the first layered negative electrode core-exposed portion 51. The surface of the sponge 63 opposite to the surface that comes in contact with the negative electrode core-exposed portion 51 is fixed to and supported by a foil pressing member 61. The sponge 63 may be omitted.

Subsequently, the welding step is performed. In the welding step, as illustrated in FIG. 7, an electrode bar 62 serving as a resistance-welding electrode moves downward in the direction indicated by arrow B. After the pressure at which the electrode bar 62 presses the negative electrode current collector 19 reaches a predetermined pressure, the electrode bar 62 is energized. Although not shown in FIG. 6 to FIG. 8, an electrode bar serving as another resistance-welding electrode is brought into contact with the outer surface of the negative electrode current collector 19 on the outer surface side of the second layered negative electrode core-exposed portion 52. Then, a resistance welding current flows through one electrode bar, the negative electrode current collector 19, the first layered negative electrode core-exposed portion 51, the negative electrode conductive member 31, the second layered negative electrode core-exposed portion 52, the negative electrode current collector 19, and the other electrode bar. As illustrated in FIG. 8, this energization melts the protrusion 31a. As a result, the negative electrode conductive member 31, the first layered negative electrode core-exposed portion 51, and the negative electrode current collector 19 are joined together and electrically connected to each other, and resistance welding is completed.

When the total number of layers of the negative electrode core-exposed portion 16 is large, a great amount of welding current is needed to form a welding mark 16a that penetrates through all the layers of the multi-layered negative electrode core-exposed portion 16 during resistance welding of the negative electrode current collector 19 to the negative electrode core-exposed portion 16. Because of this, resistance welding using the negative electrode conductive member 31 having the protrusions 31a is carried out as described above to reduce welding current.

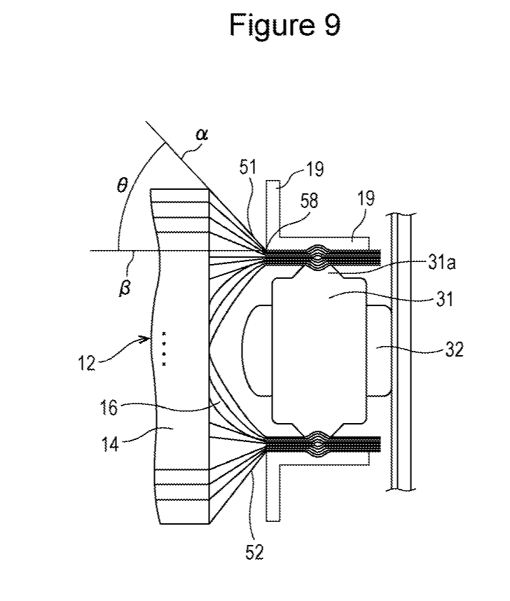

To achieve high-capacity batteries, the proportion of an active material in batteries may be increased by relatively increasing the thickness of an active material mixture layer in a positive/negative electrode plate or by increasing the width of active material layers on a core. In this case, with reference to FIG. 9, which is a partially enlarged view on the negative electrode side of FIG. 2B, the angle (hereinafter referred to as a current collection angle) θ between the axial direction 13 of the wound electrode body 14 and the extending direction a in which the negative electrode core-exposed portion 51 on the outer circumferential side of the negative electrode plate 12 extends to the contact end 58 in contact with the negative electrode current collector 19 is steep. As a result, a large stress is applied to the negative electrode core-exposed portion 51 on the outer side. In such circumstances, melting of the protrusions 31a causes the negative electrode current collector 19 to move toward the negative electrode conductive member 31, and the first layered negative electrode core-exposed portion 51 is pulled toward the negative electrode conductive member 31. As a result, the current collection angle θ is further increased, and a large stress is applied to the negative electrode core-exposed portion 51 on the outer side. However, the negative electrode core-exposed portion 51 on the negative electrode side does not break in the prismatic secondary battery 10 of the present disclosure. In the coating, compressing, and slitting steps in the production of the negative electrode plate 12, no wrinkles are formed in the negative electrode plate 12 even if the negative electrode plate 12 is stretched. The reason for this will be next described based on Examples.

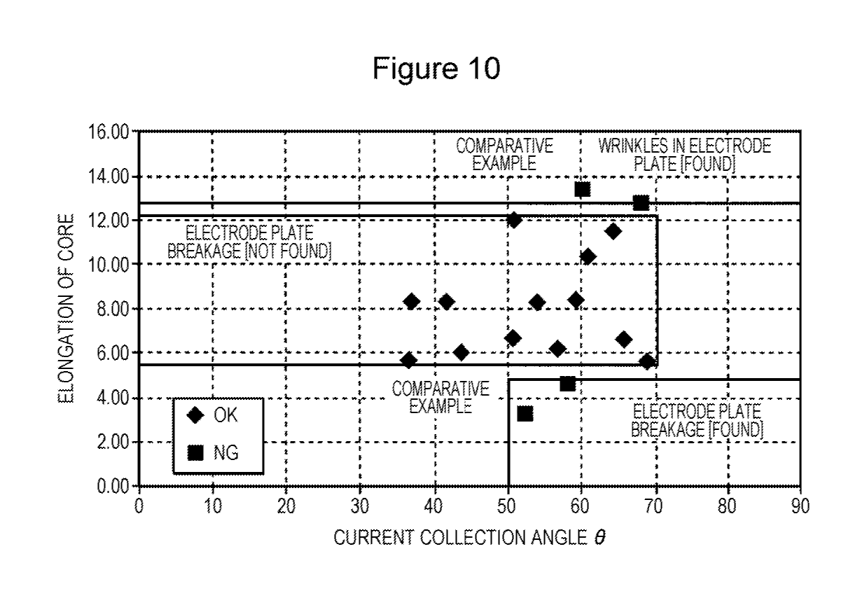

Examples according to the present disclosure will be described below in detail with reference to Table and FIG. 10. Table shows the breaking elongation of the negative electrode core, occurrence of breakage of the negative electrode plate, and formation of wrinkles in the negative electrode plate in the batteries of Comparative Examples and Examples where the current collection angle θ on the negative electrode side is different. The present disclosure is not limited to Examples.

TABLE

| | Current | | Electrode | Wrinkles in |
|---|---|---|---|---|
| | Collection | Elongation | Plate | Electrode |
| | Angle Θ | of Core | Breakage | Plate |
| Comparative | 68° | 12.5% | Not Found | Found |
| Example 1 | | | | |
| Comparative | 38° | 4.6% | Found | Not Found |
| Example 2 | | | | |
| Comparative | 58° | 4.6% | Found | Not Found |
| Example 3 | | | | |
| Example 1 | 58° | 5.6% | Not Found | Not Found |
| Example 2 | 69° | 5.6% | Not Found | Not Found |
| Example 3 | 50° | 12.0% | Not Found | Not Found |

### Production of Prismatic Secondary Batteries of Examples and Comparative Examples

The prismatic secondary batteries of Examples and Comparative Examples were produced by the method using resistance welding described with reference to FIG. 1A to FIG. 8. The prismatic secondary batteries of Examples and Comparative Examples were produced in the same manner except for the breaking elongation of the copper core, which is a negative electrode core, and the current collection angle θ described in FIG. 9. The current collection angle θ was varied by adjusting a contact end 58 (see FIG. 9) of the negative electrode core-exposed portion 51 on the outer circumferential side in contact with the negative electrode current collector 19. The following components were used as components common to the prismatic secondary batteries of Examples and Comparative Examples.

### Positive Electrode Plate

A positive electrode active material mixture layer was formed on each surface of an aluminum foil 15 μm in thickness. The thickness of the positive electrode active material mixture layer on each surface was 74 μm after compression. The length of the positive electrode plate in the transverse direction was 131.8 mm. The width (the length in the transverse direction) of the positive electrode core-exposed portion was 15.7 mm. The length of the positive electrode plate in the longitudinal direction was 5000 mm. The positive electrode active material mixture layer contained LiNi_{0.35}Co_{0.35}Mn_{0.30}O₂ serving as a positive electrode active material, carbon black serving as a conductive agent, and polyvinylidene fluoride (PVdF) serving as a binder at a mass ratio of 92:5:3.

### Negative Electrode Plate

A negative electrode active material mixture layer was formed on each surface of a copper foil 10 μm in thickness. The thickness of the negative electrode active material mixture layer on each surface was 68 μm after compression. The length of the negative electrode plate in the transverse direction was 133.8 mm. The width (the length in the transverse direction) of the negative electrode core-exposed portion was 10.0 mm. The length of the negative electrode plate in the longitudinal direction was 5200 mm.

The negative electrode active material mixture layer contained graphite serving as a negative electrode active material, carboxymethyl cellulose (CMC), and styrene-butadiene rubber (SBR) at a mass ratio of 98:1:1.

### Separator

A separator was a three-layer separator composed of polyethylene/polypropylene/polyethylene. The thickness of the separator was 12 μm.

### Wound Electrode Body

The winding number of the positive electrode plate was 33, that is, the number of layers of the positive electrode plate was 66. The length of a wound electrode body in the direction in which the winding axis extended was 144 mm. The length of the wound electrode body in the direction perpendicular to the direction in which the winding axis extended was 82 mm. The thickness of the wound electrode body was 22.5 mm.

### Current Collecting Component

A negative electrode current collector was made of a copper sheet 0.8 mm in thickness. A negative electrode conductive member had a columnar copper body (12 mm in height and 8.5 mm in diameter) with a protrusion on each surface (1.5 mm in height and 2.5 mm in bottom diameter).

### Evaluation

### Evaluation of Electrode Plate Breakage

After the negative electrode current collector 19 was connected to the negative electrode core-exposed portion 16 by resistance welding, the negative electrode core-exposed portion 16 was visually observed. When one or more visually recognizable breakages were found in samples (n=100 or more), it was determined that there was electrode plate breakage. Otherwise, it was determined that there was no electrode plate breakage.

### Evaluation of Formation of Wrinkles

A negative electrode plate was produced by applying to a negative electrode core a negative electrode active material mixture slurry containing a negative electrode active material, a binder, and a dispersion medium, such as water, drying the negative electrode active material mixture slurry to form a negative electrode active material mixture layer, and compressing the active material mixture layer. The compressed negative electrode plate was visually observed to determine whether wrinkles were formed. The batteries that underwent flowing position defects and/or rolling misalignment in the slitting step and/or the rolling-up step after compression even though there were no wrinkles according to visual observation were determined to have wrinkles.

### Evaluation Results

In the evaluation of electrode plate breakage, breakage of the negative electrode core was found in Comparative Examples 2 and 3 where the breaking elongation of the negative electrode core was 4.6%. However, breakage of the negative electrode core was not found in Examples 1 and 2 where the breaking elongation of the negative electrode core was 5.6%, Example 3 where the breaking elongation of the negative electrode core was 12.0%, and Comparative Example 3 where the breaking elongation of the negative electrode core was 12.5%.

In the evaluation of formation of wrinkles in the negative electrode plate, wrinkles were found in Comparative Example 3 where the breaking elongation of the negative electrode core was 12.5%. However, no wrinkles were found in Comparative Example 2 or 3 where the breaking elongation of the negative electrode core was 4.6%, Example 1 or 2 where the breaking elongation of the negative electrode core was 5.6%, or Example 3 where the breaking elongation of the negative electrode core was 12.0%.

In Comparative Example 2 and Comparative Example 3, the same results were obtained in the evaluation of breakage of the negative electrode core and the evaluation of formation of wrinkles. In Comparative Example 2, the breaking elongation of the negative electrode core was 4.6% and the current collection angle θ was 38 degrees. In Comparative Example 3, the breaking elongation of the negative electrode core was 4.6% which was the same as that in Comparative Example 2 but the current collection angle θ was 58 degrees which was much larger than that in Comparative Example 2.

In Example 1 and Example 2, the same results were obtained in the evaluation of breakage of the negative electrode core and the evaluation of formation of wrinkles. In Example 1, the breaking elongation of the negative electrode core was 5.6% and the current collection angle θ was 58 degrees. In Example 2, the breaking elongation of the negative electrode core was 5.6% which was the same as that in Example 1 but the current collection angle θ was 69 degrees which was different from that in Example 1.

In Comparative Example 2, breakage of the negative electrode core was found even though the current collection angle θ was as small as 38 degrees. In Comparative Example 1, breakage of the negative electrode core was not found even though the current collection angle θ was as large as 68 degrees.

The inventors of the present disclosure have further carried out examination and investigation for many samples by the same methods as those described above. The results are shown in FIG. 10. As illustrated in FIG. 10, neither breakage of the negative electrode core nor formation of wrinkles was found regardless of the current collection angle θ when the breaking elongation of the negative electrode core was in the range from 5.6% to 12.0%. However, it was easy to form wrinkles in the negative electrode plate when the breaking elongation of the negative electrode core was larger than 12.5%. As described above, the current collection angle θ increases as the capacity of the battery increases and the thickness of the active material mixture layer increases from a qualitative standpoint. This may make it easy to break the negative electrode core on the outer circumferential side of the negative electrode plate. However, the results of FIG. 10 indicate that the negative electrode core did not break even when the current collection angle θ was as large as 50 degrees or larger (70 degrees or smaller) as long as the breaking elongation of the negative electrode core was 5.6% or more.

The above-described results revealed the following facts. Specifically, the prismatic secondary battery is formed by bringing the protrusions on the negative electrode conductive member into contact with the inner side of the layered negative electrode core-exposed portion, and melting the protrusions by resistance welding with the layered negative electrode core-exposed portion sandwiched between the negative electrode conductive member and the negative electrode current collector to integrate the negative electrode current collector, the layered negative electrode core-exposed portion, and the negative electrode conductive member. When the prismatic secondary battery is produced by using a negative electrode core having a breaking elongation of 5.6% or more or 12.0% or less, a favorable prismatic secondary battery in which it is difficult to break the negative electrode plate and to form wrinkles in the negative electrode can be produced.

Furthermore, the quality of the welded zone can be stabilized because the negative electrode conductive member is provided with the protrusions in order to perform resistance welding. In a case where the current collection angle θ is 50 degrees or larger in order to obtain a high-capacity battery, it is easy to apply a large stress to the negative electrode core-exposed portion on the outer circumferential side. Therefore, the advantageous effects of the present disclosure become remarkable when the current collection angle θ is 50 degrees or more.

The present disclosure is not limited to the embodiments described above and modifications thereof, and various improvements and changes can be made without departing from the subject matters described in the claims of this application and the equivalents thereof.

For example, in the embodiments described above, the negative electrode conductive member 31 is provided with, at its both ends in the extending direction, the respective protrusions 31a which are to melt during resistance welding. However, the negative electrode conductive member is not necessarily provided with the protrusions which are to melt during resistance welding although the negative electrode conductive member is provided. Alternatively, a protrusion that is to melt during resistance welding may be formed on the negative electrode current collector on the layered negative electrode core-exposed portion side to perform resistance welding. Alternatively, the layered negative electrode core-exposed portion may not be divided into two parts, so that the negative electrode conductive member may not be disposed. A protrusion may be formed on the negative electrode current collector on the layered negative electrode core-exposed portion side to perform resistance welding. However, the negative electrode conductive member with the protrusions is preferably used.

Even when the prismatic secondary battery is a high-capacity battery having such a structure, a negative electrode core having a breaking elongation of 5.6% or more and 12.0% or less is used. Because of such a negative electrode core, breakage of the negative electrode plate and formation of wrinkles in the negative electrode plate can be suppressed during welding even if the layered negative electrode core-exposed portion is pulled as a result of melting of the protrusions by resistance welding, and a large stress is applied to the sloped outer circumferential side of the layered negative electrode core-exposed portion. Therefore, a quality prismatic secondary battery with a high capacity can be produced at high productivity.

The method for connecting the positive electrode core-exposed portion and the positive electrode current collector is not limited. For example, resistance welding, ultrasonic welding, or laser welding can be used to connect the positive electrode core-exposed portion and the positive electrode current collector.

The flat electrode body may be a wound electrode body or may be a stacked electrode body containing positive electrode plates and negative electrode plates.

A resin film may be disposed around the welded zone between the negative electrode current collector 19 and the negative electrode core-exposed portion 16 and located between the negative electrode current collector 19 and the negative electrode core-exposed portion 16.

The negative electrode conductive member and the negative electrode current collector may both be provided with a protrusion. The protrusion on the negative electrode conductive member or the negative electrode current collector is melted by resistance welding, but the entire protrusion does not necessarily disappear and part of the protrusion may remain.

The positive electrode core is preferably made of a metal foil, preferably an aluminum foil or an aluminum alloy foil. The thickness of the positive electrode core is preferably 10 μm to 30 μm, more preferably 10 μm to 20 μm, and still more preferably 12 μm to 18 μm. The thickness of the positive electrode active material mixture layer on one surface of the positive electrode core is preferably 50 μm to 150 μm, more preferably 50 μm to 100 μm, and still more preferably 60 μm to 90 μm.

The negative electrode core is preferably made of a copper foil or a copper alloy foil. The thickness of the negative electrode core is preferably 5 μm to 30 μm, more preferably 5 μm to 20 μm, and still more preferably 8 μm to 15 μm. The thickness of the negative electrode active material mixture layer on one surface of the negative electrode core is preferably 50 μm to 150 μm, more preferably 50 μm to 100 μm, and still more preferably 60 μm to 90 μm.

### Others

The materials for the positive electrode plate, the negative electrode plate, the separator, the electrolyte, and other components are known materials used for secondary batteries. For example, the following materials are preferably used for lithium-ion secondary batteries.

Examples of suitable positive electrode active materials include lithium-transition metal composite oxides. Examples of lithium-transition metal composite oxides include lithium cobalt oxide, lithium manganese oxide, lithium nickel oxide, lithium nickel manganese composite oxide, lithium nickel cobalt composite oxide, and lithium nickel cobalt manganese composite oxide. These lithium-transition metal compound oxides further containing, for example, Al, Ti, Zr, W, Nb, B, Mg, or Mo may also be used. Alternatively, olivine-type lithium iron phosphate can also be used.

A carbon material that can intercalate and deintercalate lithium ions is preferably used as a negative electrode active material. Examples of carbon materials that can intercalate and deintercalate lithium ions include graphite, non-graphitizable carbon, graphitizable carbon, fibrous carbon, corks, and carbon black. Among these, graphite is particularly preferred. Examples of non-carbon materials include silicon, tin, and alloys and oxides mainly composed of silicon or tin.

Examples of non-aqueous solvents (organic solvents) for the non-aqueous electrolyte include carbonates, lactones, ethers, ketones, and esters. These solvents may be used as a mixture of two or more. Examples of electrolyte salts for the non-aqueous electrolyte include electrolyte salts that have commonly been used in lithium-ion secondary batteries known in the art.

A porous resin film is preferably used as a separator. For example, a porous polyolefin separator is preferably used.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A method for producing a prismatic secondary battery including a flat electrode body containing a positive electrode plate and a negative electrode plate,
the negative electrode plate including a negative electrode core made of a copper foil or a copper alloy foil and a negative electrode active material mixture layer on the negative electrode core,
the flat electrode body having a layered negative electrode core-exposed portion at an end portion,
the layered negative electrode core-exposed portion including a first layered negative electrode core-exposed portion and a second layered negative electrode core-exposed portion with a distance therebetween,
the prismatic secondary battery further including a current collector electrically connected to two outermost surfaces of the layered negative electrode core-exposed portion, and a conductive member made of a metal between the first layered negative electrode core-exposed portion and the second layered negative electrode core-exposed portion,
the method comprising:
a placing step of placing the current collector on outer sides of two outermost surfaces of the layered negative electrode core-exposed portion and placing the conductive member between the first layered negative electrode core-exposed portion and the second layered negative electrode core-exposed portion, the conductive member having protrusions; and
a welding step of bringing a resistance-welding electrode into contact with the current collector from a side opposite to a layered negative electrode core-exposed portion side, and resistance-welding the current collector, the layered negative electrode core-exposed portion, and the conductive member together,
wherein the negative electrode core has a breaking elongation of 5.6% or higher and 12.0% or lower,
wherein, during the welding step, the protrusions on the conductive member are melted by causing a resistance welding current to flow while the protrusions on the conductive member contact the negative electrode core-exposed portion located between the conductive member and the current collector.

2. A method for producing a prismatic secondary battery including a flat electrode body containing a positive electrode plate and a negative electrode plate,
the negative electrode plate including a negative electrode core made of a copper foil or a copper alloy foil and a negative electrode active material mixture layer on the negative electrode core,
the flat electrode body having a layered negative electrode core-exposed portion at an end portion,
a current collector being placed on an outermost surface of the layered negative electrode core-exposed portion,
the method comprising:
a placing step of placing the current collector on the outermost surface of the layered negative electrode core-exposed portion, the current collector having a protrusion; and
a welding step of bringing a resistance-welding electrode into contact with the current collector from a side opposite to a layered negative electrode core-exposed portion side and resistance-welding the current collector and the negative electrode core-exposed portion together,
wherein the negative electrode core has a breaking elongation of 5.6% or higher and 12.0% or lower,
wherein, during the welding step, the protrusion on the current collector is melted by causing a resistance welding current to flow while the protrusion on the current collector contacts the negative electrode core-exposed portion.
